(19) United States
(12) Patent Application Publication
(10) Pub. No.: US 2007/0035486 A1
(43) Pub. Date: Feb. 15, 2007

(54) SIGNAL TRANSMISSION CIRCUIT, ELECTRO-OPTICAL DEVICE, AND ELECTRONIC APPARATUS

(75) Inventor: Toshiyuki Kasai, Suwa-shi, Nagano-ken (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/461,190

(22) Filed: Jul. 31, 2006

(30) Foreign Application Priority Data
Aug. 12, 2005 (JP) 2005-234047

(51) Int. Cl. G09G 3/30

(52) U.S. Cl. 345/76

(57) ABSTRACT

A signal transmission circuit includes: an electro-optical substrate having electro-optical elements; a plurality of driving circuits that drives the electro-optical elements; a first connection path that electrically connects the plurality of driving circuits; and a first substrate including at least a part of the first connection path. The electro-optical substrate is formed of a substrate different from the first substrate.

### BACKGROUND

1. Technical Field

The present invention relates to a signal transmission circuit, to an electro-optical device, and to an electronic apparatus. In particular, the invention relates to a signal transmission circuit, to an electro-optical device, and to an electronic apparatus suitable for a case in which a plurality of circuits are cascade-connected.

2. Related Art

Devices having organic light-emitting diode elements (hereinafter, referred to as ‘OLED elements’) have been drawing attention as electro-optical devices that can replace liquid crystal display devices. From an electrical point of view, an OLED element operates in the same manner as a diode, and from an optical point of view, the OLED element emits light at a forward bias and the brightness of the emitted light increases as a forward bias current increases.

An electro-optical device in which OLED elements are arrayed in a matrix includes a plurality of scanning lines, a plurality of data lines, and pixel circuits corresponding to intersections of the scanning lines and the data lines. That is, the pixel circuits arrayed in a matrix form a pixel region serving as a display unit. Here, each of the pixel circuits has a function of storing a value of a current supplied from the data line and supplying to the OLED element a driving current corresponding to the stored current value.

Further, the electro-optical device described above includes data-line driving circuits that supply gray-scale signals, which are current signals corresponding to gray-scale levels to be displayed, to the plurality of data lines. Here, when the gray-scale signals are transmitted to the data-line driving circuits, a known common bus transmission method using a relatively simple configuration has been used.

A know electro-optical device using a common bus transmission method is shown in FIG. 13. As shown in FIG. 13, an electro-optical device 600 includes an electro-optical substrate 610, a printed circuit board 620, and a plurality of relay FPCs 630a to 630n provided between the electro-optical substrate 610 and the printed circuit board 620. An image region A and a data-line driving circuit 700 are formed on the electro-optical substrate 610, the printed circuit board 620, and the plurality of relay FPCs 630a to 630n.

The image region A is formed by disposing electro-optical elements serving as pixels in a matrix, and the image region A serves as a display unit. The data-line driving circuit 700 includes a plurality of driving circuits Dr1 to DrN disposed on the electro-optical substrate 610, a common bus 621 disposed on the printed circuit board 620, and wiring lines 631a to 631n that are disposed on the relay FPCs 630a to 630n so as to electrically connect the driving circuits Dr1 to DrN with the common bus 621. An X clock signal XCLK, gray-scale data D, and a selection signal that a control circuit 650 transmits through a relay FPC 660 are transmitted to the driving circuits Dr1 to DrN through the common bus 621 and the wiring lines 631a to 631n.

In the electro-optical device 600, the gray-scale data D and the like transmitted from the control circuit 650 are transmitted to all of the driving circuits Dr1 to DrN through the common bus 621 and the wiring lines 631a to 631n. However, due to the selection signal transmitted concurrently with the gray-scale data D and the like, only a driving circuit corresponding to the selection signal is input with the gray-scale data D.

However, in the electro-optical device 600, in order to transmit the gray-scale data D and the like transmitted from the control circuit 650, it is necessary to dispose the common bus 621 on the printed circuit board 620 such that the common bus 621 corresponds to the locations of the driving circuits Dr1 to DrN provided on the electro-optical substrate 610.

Therefore, the shape of the printed circuit board 620 needs to correspond to the locations of the driving circuits Dr1 to DrN provided on the electro-optical substrate 610. Specifically, the printed circuit board 620 should have a length corresponding to a region where the driving circuits Dr1 to DrN are provided on the electro-optical substrate 610. Accordingly, as the number of driving circuits Dr1 to DrN provided on the electro-optical substrate 610 increases, there has been a problem in that the printed circuit board 620 becomes longer. Further, since a main purpose of the printed circuit board 620 is to transmit the gray-scale data D and the like transmitted from the control circuit 650, it is not efficient from a point of view of resource and material cost to make the printed circuit board 620 long.

In order to solve the problem described above, for example, techniques disclosed in JP-A-8-146449 and JP-A-2001-174843 have been proposed. In the technique disclosed in JP-A-8-146449, an electro-optical substrate, on which a plurality of driving circuits are disposed, and a flexible wiring substrate, on which a common bus connected to the driving circuits is disposed, are provided and gray-scale data or the like is supplied to each of the driving circuits through a connection point provided between the driving circuits. Further, in the technique disclosed in JP-A-2001-174843, a plurality of driving circuits and a data-line driving circuit, in which the plurality of driving circuits are electrically cascade-connected to each other, are disposed on an electro-optical substrate and gray-scale data or the like is cascade-transmitted between adjacent driving circuits.

According to the technique disclosed in JP-A-8-146449, an area of a substrate required to dispose wiring lines may be reduced. However, since the common bus and the driving circuits are connected to each other at short sides of the driving circuits, the number of signals is limited to the number of terminals that can be provided at the short sides of the driving circuits. Accordingly, in the case when the number of signals is larger than the limited number, a problem occurs where a space between adjacent driving circuits should be widened.

Further, according to the technique disclosed in JP-A-2001-174843, an area of a substrate required to dispose wiring lines may be reduced, in the same manner as the technique disclosed in JP-A-8-146449. However, since the cascade-connected driving circuits are directly disposed on an electro-optical device that is a glass substrate, a problem occurs where it is not possible to provide, for example, capacitors for stabilizing power supplied to the driving circuits. In addition, since the driving circuits are cascade-connected to each other by using relatively nigh-resistance wiring lines such as thin-film wiring lines, a voltage applied to the wiring lines drops as the driving circuits is separated from a power supply (voltage drop). As a result, there is a possibility that driving circuits disposed far from the power supply may malfunction.

### SUMMARY

An advantage of some aspects of the invention is that it provides a signal transmission circuit that can reduce an area of a substrate required to dispose wiring lines, can be used even when many signal lines are required, can suppress voltage drop in the wiring lines, and is highly reliable, an electro-optical device having the signal transmission circuit, and an electronic apparatus having the electro-optical device.

According to an aspect of the invention, a signal transmission circuit includes: an electro-optical substrate having electro-optical elements; a plurality of driving circuits that drives the electro-optical elements; a first connection path that electrically connects the plurality of driving circuits; and a first substrate including at least a part of the first connection path. The electro-optical substrate is formed of a substrate different from the first substrate.

In the signal transmission circuit according to the aspect of the invention, it is possible to reduce an area of a substrate required to dispose wiring lines.

In the signal transmission circuit described above, preferably, the driving circuits are mounted on the electro-optical substrate.

In the signal transmission circuit, it is possible to even more reduce the area of the substrate required to dispose the wiring lines.

Further, in the signal transmission circuit described above, preferably, the first connection path serves as a connection path between the driving circuits adjacent to each other.

In the signal transmission circuit, it is possible to even more reduce the area of the substrate required to dispose the wiring lines.

Furthermore, in the signal transmission circuit described above, preferably, at least a part of the first connection path is formed on the electro-optical substrate and the first substrate.

In the signal transmission circuit, it is possible to even more reduce the area of the substrate required to dispose the wiring lines.

Furthermore, in the signal transmission circuit described above, preferably, each of the driving circuits has an approximately rectangular planar shape, and the at least a part of the first connection path is connected at a longitudinal side of each of the driving circuits having an approximately rectangular planar shape.

In the signal transmission circuit, it is possible to connect the driving circuits so as to use even more signals.

Furthermore, in the signal transmission circuit described above, preferably, at least a part of a connection path provided on the first substrate has a contact region that is electrically conductive.

In the signal transmission circuit, an auxiliary power line, a capacitor, or the like can be easily connected.

Furthermore, in the signal transmission circuit described above, preferably, the connection path provided on the first substrate includes a power line, and a capacitor is mounted on the contact region provided on the power line.

In the signal transmission circuit, it is possible to stably (smoothly) supply power to each driving circuit.

Furthermore, in the signal transmission circuit described above, preferably, the connection path provided on the first substrate includes a power line, and a wiring line for a reduction of the power line impedance is mounted on the contact region provided on the power line.

In the signal transmission circuit, it is possible to reduce voltage drop in the wiring lines.

Furthermore, in the signal transmission circuit described above, preferably, the wiring line for a reduction of the power line impedance is commonly connected between the plurality of first substrates.

In the signal transmission circuit, it is possible to easily prepare the wiring line for a reduction of the power line impedance.

Furthermore, in the signal transmission circuit described above, preferably, the connection path provided on the first substrate includes a power line, and the contact region provided on the power line is connected between a plurality of the first substrates.

In the signal transmission circuit, it is possible to reduce the voltage drop in the wiring lines.

Furthermore, according to another aspect of the invention, an electro-optical device includes: the signal transmission circuit according to the above-mentioned aspect of the invention; and a second substrate having a control circuit that controls the signal transmission circuit.

In the invention, it is possible to provide an electro-optical device that is small and highly reliable.

Furthermore, according to still another aspect of the invention, an electronic apparatus includes: the electro-optical device according to the above-mentioned aspect of the invention; and a circuit that controls the electro-optical device.

In the invention, it is possible to provide an electronic apparatus that is small and highly reliable.

### BRIEF DESCRIPTION OF THE DRAWINGS

The invention will be described with reference to the accompanying drawings, wherein like numbers reference like elements.

FIG. 1 is a block diagram illustrating an electro-optical device according to a first embodiment of the invention.

FIG. 2 is a timing chart illustrating scanning signals and emission control signals in FIG. 1.

FIG. 3 is a circuit diagram illustrating a pixel circuit in FIG. 1.

FIG. 4 is a circuit diagram illustrating a data-line driving circuit in FIG. 1.

FIG. 5 is a circuit diagram illustrating wiring lines on a wiring substrate in FIG. 1.

FIG. 6 illustrates a circuit diagram when wiring lines on a wiring substrate are provided with lands.

FIG. 7 illustrates a circuit diagram when auxiliary power lines are connected to lands on a wiring substrate.

FIG. 8 illustrates a circuit diagram when a capacitor is connected to lands on a wiring substrate.

FIG. 9 is a circuit diagram illustrating a pixel circuit according to a second embodiment of the invention.

FIG. 10 is a perspective view illustrating the configuration of a portable personal computer to which the electro-optical device is applied.

FIG. 11 is a perspective view illustrating the configuration of a mobile phone to which the electro-optical device is applied.

FIG. 12 is a perspective view illustrating the configuration of a personal digital assistant to which the electro-optical device is applied.

FIG. 13 is a view schematically illustrating a known electro-optical device.

### DESCRIPTION OF EXEMPLARY EMBODIMENTS

Hereinafter, exemplary embodiments of the invention will be described. The embodiments described herein are for illustrative purposes and are not intended to limit the present invention.

First Embodiment

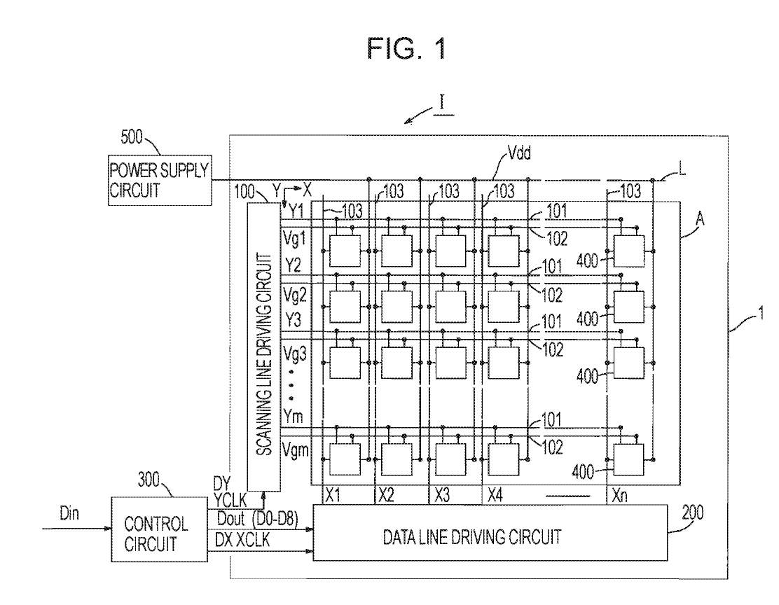

FIG. 1 is a block diagram schematically illustrating the configuration of an electro-optical device according to a first embodiment of the invention. As shown in FIG. 1, the electro-optical device I includes an image region A, a scanning-line driving circuit 100, a data-line driving circuit 200, a control circuit 300, and a power supply circuit 500. The image region A and the scanning-line driving circuit 100 are formed on an electro-optical substrate 1 that is a glass substrate, and the data-line driving circuit 200 is formed on the electro-optical substrate 1, and a wiring substrate that includes a plurality of flexible printed circuits (FPC) connected to the electro-optical substrate 1. In addition, the control circuit 300 is formed on a control circuit substrate that is a printed circuit board (PCB). In addition, in the present embodiment, the wiring substrate corresponds to a first substrate and the control circuit substrate corresponds to a second substrate, respectively.

In the image region A, ‘m’ scanning lines 101 and ‘m’ emission control lines 102 are formed parallel to the X direction, and ‘n’ data lines 103 are formed parallel to the Y direction perpendicular to the X direction. In addition, pixel circuits 400 each having an OLED element are provided at intersections between the scanning lines 101 and the data lines 103. Further, a power supply voltage Vdd is supplied to each of the pixel circuits 400 through a power line L.

The scanning-line driving circuit 100 generates scanning signals Y1, Y2, Y3, . . . , and Ym for sequentially selecting the plurality of scanning lines 101 and emission control signals Vg1, Vg2, Vg3, . . . , and Vgm at the same time. The scanning signals Y1, Y2, Y3, . . . , and Ym and the emission control signals Vg1, Vg2, Vg3, . . . , and Vgm are generated by sequentially transmitting a Y transmission start pulse DY in synchronization with a Y clock signal YCLK. The emission control signals Vg1, Vg2, Vg3, . . . and Vgm are supplied to the corresponding pixel circuits 400 through the corresponding emission control lines 102.

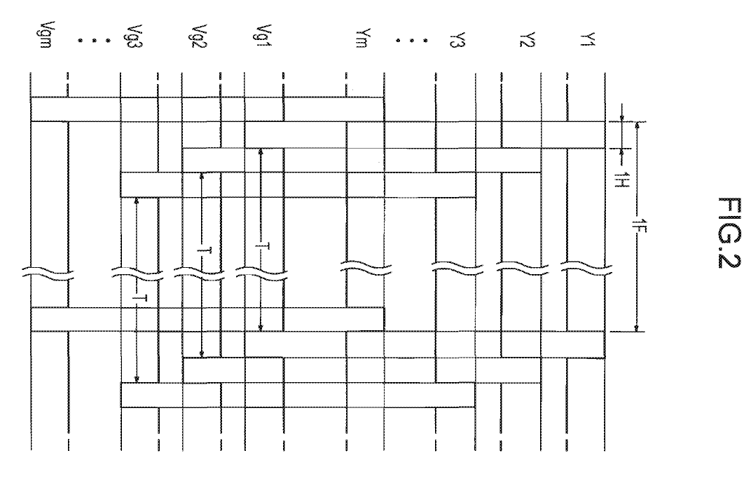

FIG. 2 is a view illustrating an example of a timing chart with respect to the scanning signals Y1, Y2, Y3, . . . , and Ym and the emission control signals Vg1, Vg2, Vg3, . . . , and Vgm. The scanning signal Y1 is a pulse having a width corresponding to one horizontal scanning period 1H, which starts from an initial timing of one vertical scanning period 1F, and is supplied to the scanning line 101 at a first row. Subsequently, the pulse is sequentially shifted to be supplied to the scanning lines 101 at second, third, . . . , and m-th rows as the scanning signals Y2, Y3, . . . , and Ym, respectively. In general, when a scanning signal Yi supplied to the scanning line 101 at an i-th row (‘i’ is an integer in a range of 1≦i≦m) transitions to an H level, the corresponding scanning line 101 is selected. In addition, as the emission control signals Vg1, Vg2, Vg, . . . , and Vgm, for example, signals obtained by inverting logic levels of the scanning signals Y1, Y2, Y3, . . . , and Ym are used as the emission control signals Vg1, Vg2, Vg3, . . . , and Vgm.

The data-line driving circuit 200 supplies gray-scale signals, which are generated on the basis of gray-scale components D0 to D8, to the corresponding pixel circuits 400 located at the selected scanning lines 101 on the basis of output gray-scale data Dout. In the present embodiment, the gray-scale components D0 to D8 are regenerated as current signals X1, X2, X3, X4, . . . , and Xn that indicate the gray-scale brightness. Further, the gray-scale components D0 to D8 are components of the output gray-scale data Dout, which is digital data corresponding to pixels, and, for example, a 9-bit signal in which bit-unit signals are disposed in a predetermined arrangement in order to include as information the gray-scale level indicating the brightness of each pixel.

The control circuit 300 generates various control signals, such as the Y clock signal YCLK, an x clock signal XCLK, an X transmission starting pulse DX, and the Y transmission start pulse DY, and then outputs the signals to the scanning-line driving circuit 100 and the data-line driving circuit 200. In addition, the control circuit 300 performs an image processing, such as gamma correction, on input gray-scale data Din and then generates output gray-scale data Dout. In the output gray-scale data Dout, for example, gray-scale components D0 to D8, which consist of 9 bits, are disposed in a predetermined arrangement.

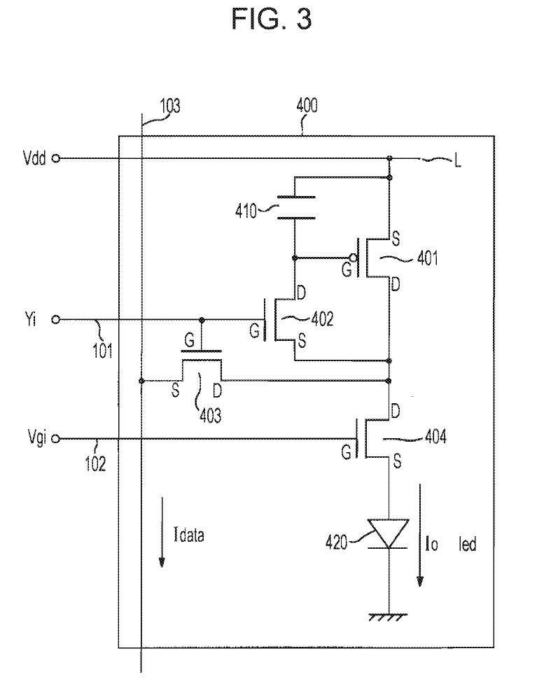

Next, the pixel circuit 400 will be described. FIG. 3 is a circuit diagram illustrating the pixel circuit 400. The pixel circuit 400 shown in FIG. 3 corresponds to the i-th row, and a power supply voltage Vdd is supplied to the pixel circuit 400. The pixel circuit 400 includes four TFTs 401 to 404, a capacitive element 410, and an OLED element 420. In a process of manufacturing the TFTs 401 to 404, a polysilicon layer is formed on a glass substrate by using laser annealing. In addition, in the OLED element 420, a light-emitting layer is interposed between an anode and a cathode. Further, the OLED element 420 emits light with brightness corresponding to a forward current. For the light-emitting layer, an organic EL (electroluminescent) material corresponding to the color of light to be emitted is used. In a process of manufacturing the light-emitting layer, the organic EL material is discharged from an inkjet-type head and is then dried.

The TFT 401 serving as a driving transistor is a p-channel transistor, and the TFTs 402 to 404 serving as switching transistors are n-channel transistors. A source electrode of the TFT 401 is connected to a power line L and a drain electrode of the TFT 401 is connected to a drain electrode of the TFT 403, a drain electrode of the TFT 404, and a source electrode of the TFT 402.

One end of the capacitive element 410 is connected to the source electrode of the TFT 401 and the other end of the capacitive element 410 is connected to a gate electrode of the TFT 401 and a drain electrode of the TFT 402. A gate electrode of the TFT 403 is connected to the scanning line 101 and a source electrode of the TFT 403 is connected to the data line 103. Furthermore, a gate electrode of the TFT 402 is connected to the scanning line 101. Further, a gate electrode of the TFT 404 is connected to the emission control line 102 and a source electrode of the TFT 404 is connected to the anode of the OLED element 420. The emission control signal Vgi is supplied to the gate electrode of the TFT 404 through the emission control line 102. In addition, the cathode of the OLED element 420 serves as a common electrode for the entire pixel circuit 400 and serves as a low (reference) potential in a power supply.

In the configuration described above, since the n-channel TFT 402 is turned on when the scanning signal Yi transitions to an H level, the TFT 401 serves as a diode in which the gate and drain electrodes of the TFT 401 are connected to each other. Further, when the scanning signal Yi transitions to an H level, the n-channel TFT 403 is also turned on in the same manner as the TFT 402. As a result, a currant Idata of the data-line driving circuit 200 flows through a path of the power line L→TFT 401→TFT 403→data line 103, and at the same time, charge corresponding to the potential of the gate electrode of the TFT 401 is accumulated in the capacitive element 410.

On the other hand, when the scanning signal Yi transitions to an L level, the TFTs 402 and 403 are turned off. At this time, since the input impedance of the gate electrode of the TFT 401 is extremely high, a state in which charge is accumulated in the capacitive element 410 does not change. Therefore, the gate-to-source voltage of the TFT 401 is held as a voltage When the current Idata flows. In addition, when the scanning signal Yi transitions to an L level, the emission control signal Vgi changes to an H level. Accordingly, the TFT 404 is turned on and an injection current Ioled corresponding to a voltage of the gate of the TFT 401 flows between the source and the drain of the TFT 401. That is, the injection current Ioled flows through a path of the power line L→TFT 401→TFT 404→OLED element 420.

Here, the injection current Ioled flowing through the OLED element 420 is determined by the gate-to-source voltage of the TFT 401, and the gate-to-source voltage of the TFT 401 is a voltage held by the capacitive element 410 when the current I data flows through the data line 103 due to the H-level scanning line Yi. For this reason, when the emission control signal Vgi transitions to an H level, the injection current Ioled flowing through the OLED element 420 is approximately equal to the current Idata. Thus, the pixel circuit 400 is a circuit using an active current programming method because the brightness of emitted light is determined by the current Idata.

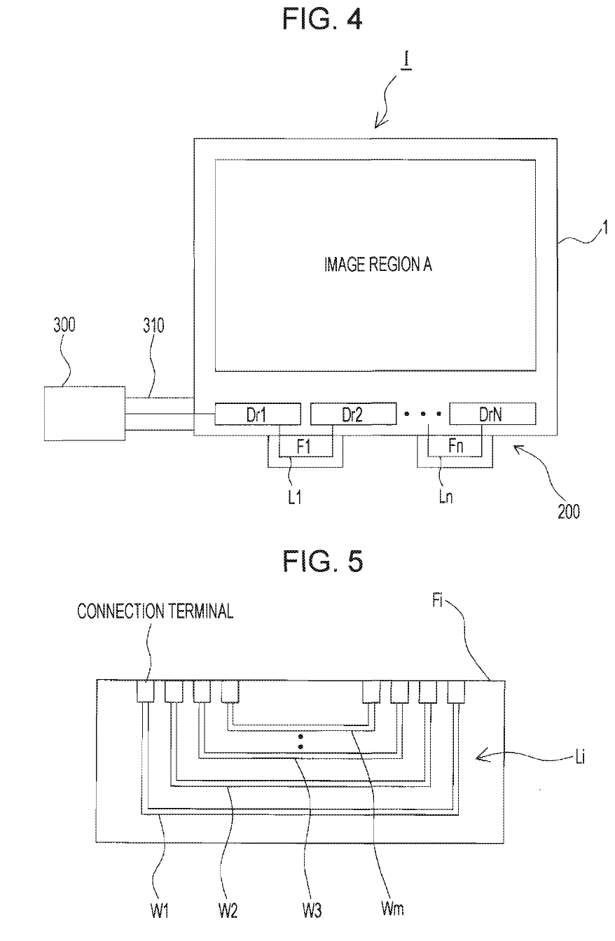

Next, the present embodiment is characterized by the configuration of the data-line driving circuit 200, which is shown in FIG. 4. As shown in FIG. 4, the data-line driving circuit 200 according to the present embodiment is formed on the electro-optical substrate 1 and a plurality of wiring substrates F1 to Fn connected to the electro-optical substrate 1. Specifically, a plurality of driving circuits Dr1, Dr2, . . . , and DrN are disposed parallel to one another on the electro-optical substrate 1, and lines L1 to Ln, which are first connection lines through which adjacent driving circuits are cascade-connected to each other, are disposed on the electro-optical substrate 1 and the wiring substrates F1 to Fn such that each of the lines L1 to Ln is connected between two of the driving circuits and goes through a corresponding one of the wiring substrates F1 to Fn connected to the electro-optical substrate 1. In addition, as shown in FIG. 5, the lines L1 to Ln are formed of a plurality of wiring lines W1 to Wm, and the X clock signal XCLK, the output gray-scale data Dout, or the like can be transmitted through the lines L1 to Ln. In addition, the wiring substrates F1 to Fn according to the present embodiment are connected to an end surface of the electro-optical substrate 1 between the driving circuits. In addition, in the present embodiment, even though all of the wiring lines W1 to Wm forming each of the lines L1 to Ln are disposed on the wiring substrates F1 to Fn, all of the wiring lines W1 to Wm are not necessarily disposed on the wiring substrates F1 to Fn. For example, parts of the wiring lines W1 to Wm may be disposed on the wiring substrates F1 to Fn.

Here, one end of each of the plurality of wiring lines W1 to Wm forming the lines L1 to Ln is connected to a terminal located at a longitudinal side of each of the driving circuits Dr1, Dr2, . . . , and DrN, respectively. Further, the pluralities of wiring lines W1 to Wm forming the lines L1 to Ln are disposed on the electro-optical substrate 1 and the wiring substrates F1 to Fn so as to go through, from the terminals, an end portion of the electro-optical substrate 1 and the wiring substrates F1 to Fn disposed between the driving circuits, respectively. Then, each of the wiring lines W1 to Wm is connected to a terminal located at a longitudinal side of an adjacent one of the driving circuits. In addition, the wiring lines W1 to Wm disposed on the electro-optical substrate 1 and the wiring line W1 to Wm disposed on the wiring substrates F1 to Fn are correspondingly connected through connection terminals that are provided at end portions of the substrates for the respective wiring lines W1 to Wm.

Thus, since the wiring lines W1 to Wm can be disposed on the wiring substrates F1 to Fn connected to the electro-optical substrate 1, it is possible to reduce the area of the electro-optical substrate 1. Further, since the wiring lines W1 to Wm can be connected to the longitudinal sides of the driving circuits Dr1 Dr2, . . . , and DrN, the driving circuits can be cascade-connected to each other so as to enable the use of even more signals. Furthermore, since a material having low electrical resistance, such as copper or aluminum, can be used as a material of wiring lines on the wiring substrates F1 to Fn, the voltage drop can be suppressed.

Further, in the present embodiment, since flexible substrates are used as the wiring substrates F1 to Fn, it is possible to make the electro-optical device I small by bending the wiring substrates F1 to Fn in the direction of a bottom surface of the electro-optical substrate 1. As a result, it is possible to improve the value of the electro-optical device I as a product due to the miniaturization.

Furthermore, in the case when problems, such as contact failure or short-circuits, occur on the wiring line W3 disposed on the wiring substrate Fi, it s possible to solve the problems by only exchanging the wiring substrate Fi. Accordingly, the productivity of the electro-optical device Ican be improved, and as a result, it is possible to reduce a cost of manufacturing the electro-optical device I.

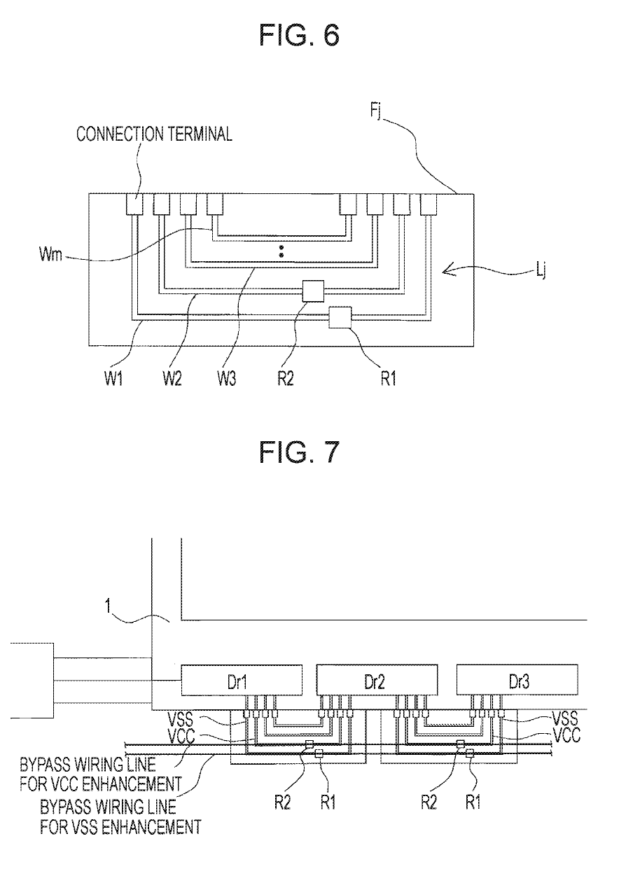

Furthermore, as shown in FIG. 6, the wiring lines W1 to Wm on the wiring substrates F1 to Fn may be provided with lands R1 and R2 that are contact regions such that an auxiliary power line, a capacitor, or the like can be connected to the lands R1 and R2. FIG. 6 is a circuit diagram when the wiring lines W1 and W2 on the wiring substrate Fj are respectively provided with the lands R1 and R2. Here, the contact region is not limited as long as the wiring lines can be electrically connected to the auxiliary power line or the like. In the present embodiment, as shown in FIG. 6, the wiring lines W1 and W2 are respectively provided with the lands R1 and R2 as contact regions. In addition, the lands R1 and R2 are formed by enlarging the width of a part of each of the wiring lines W1 and W2 connected to the lands R1 and R2, and the lands R1 and R2 can be electrically connected to, for example, an auxiliary power mine.

Specifically, for example, as shown in FIG. 7, the lands R1 and R2 may be respectively provided for a power line VSS and a ground line VCC, which are power lines provided to supply power to the driving circuits Dr1, Dr2, . . . , and DrN, among the wiring lines W1 Wm provided on the wiring substrates F1 to Fn. Further, a bypass wiring line for VSS enhancement, which serves as a wiring line for power line enhancement, may be connected to the land R1, and a bypass wiring line for VCC enhancement, which also serves as a wiring line for power line enhancement, may be connected to the land R2. The bypass wiring line for VSS enhancement is connected to a cathode of a power supply (not shown), and the bypass wiring line for VCC enhancement is connected to an anode of the power supply (not shown). In addition, through the land R1, a negative voltage is applied to the power line VSS and a positive voltage is applied to the ground line VCC. Accordingly, the voltage drop between the power line VSS and the ground line VCC can be suppressed. In addition, as a power supply connected to the bypass wiring line for VSS enhancement and the bypass wiring line for VCC enhancement, a power line of the control circuit 300 or an external power supply may be used.

With the configuration described above, since it is possible to reduce the voltage drop between the power line VSS and the ground line VCC, it is possible to improve (stabilize) a capability of supplying power to each driving circuit. Accordingly, it is possible to improve reliability or operation margin of the signal transmission circuit and electro-optical device using the signal transmission circuit. In addition, in the present embodiment, even though the bypass wiring line for VSS enhancement and the bypass wiring line for VCC enhancement are respectively connected to the power line VSS and the ground line VCC by using the lands R1 and R2 through which the bypass wiring line for VSS enhancement and the bypass wiring line for VCC enhancement can be easily connected to the power line VSS and the ground line VCC, the bypass wiring line for VSS enhancement and the bypass wiring line for VCC enhancement may be directly connected to the power line VSS and the ground line VCC, respectively.

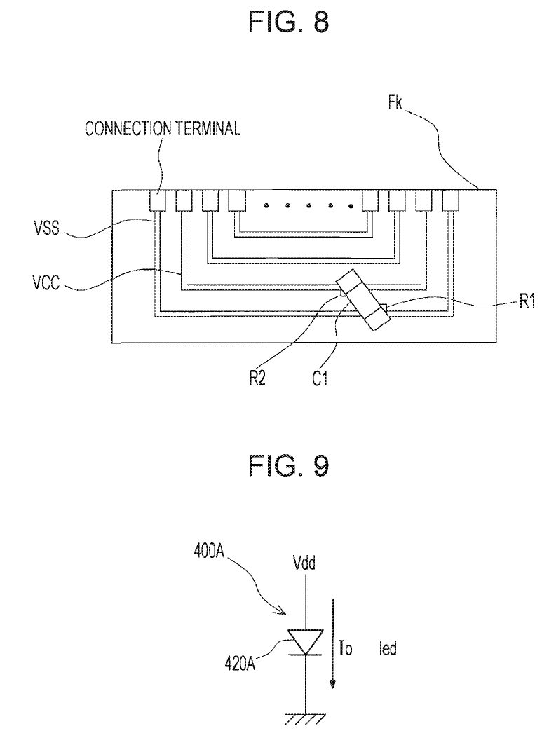

Further, as shown in FIG. 8, the lands R1 and R2 may be respectively provided for the power line VSS and the ground line VCC among the wiring lines W1 to Wm forming the lines L1 to Ln, and then a capacitor C1 may be connected between the lands R1 and R2. By providing the capacitor C1 as described above, it is possible to stabilize the capability of supplying power to each of the driving circuits Dr1 to DrN. As a result, the reliability of the signal transmission circuit and electro-optical device using the signal transmission circuit can be improved. Furthermore, in the present embodiment, even though the capacitor C1 is connected between the power line VSS and the ground line VCC by using the lands R1 and R2 through which the power line VSS and the ground line VCC can be easily connected to each other, the capacitor C1 may be directly connected between the power line VSS and the ground line VCC.

Furthermore, since the lands are provided, it is possible to check the state of a signal by probing the lands. Accordingly, the evaluation on the electro-optical device I can be performed quickly and accurately. As a result, a period of time required for development and design is shortened, which reduces cost.

Second Embodiment

Even though a circuit using an active current programming method has been used as the pixel circuit 400 in the first embodiment, a circuit using a passive current method may be used. FIG. 9 is a view illustrating a circuit using a passive current method. A pixel circuit 400A shown in FIG. 9 corresponds to an i-th row, and the power supply voltage Vdd is supplied to the pixel circuit 400A. The pixel circuit 400A includes an OLED element 420A. The OLED element 420A has the same structure as the OLED element 420 in the first embodiment and is manufactured by using the same manufacturing process as the OLED element 420 in the first embodiment.

As such, even when the circuit using the passive current method is used as the pixel circuit 400, it is possible to obtain the same effects as in the first embodiment.

Other Embodiments

In the first and second embodiments, the driving circuits have been formed on the electro-optical substrate of the electro-optical device I, on which pixel circuits are arranged in a matrix as described above, and the plurality of wiring substrates F1 to Fn connected to the electro-optical substrate; however, the invention is not limited thereto. For example, it is possible to form driving circuits on an electro-optical substrate of an electro-optical device (for example, a writing head used for an optical printer or an electronic copying machine), on which pixel circuits are arranged in a line shape, and a plurality of wiring substrates connected to the electro-optical substrate. Alternatively, the driving circuits may be formed on an electro-optical substrate of an electro-optical device, which is made of an organic light-emitting material using monomer, polymer, dendrimer, or the like, and a plurality of wiring substrates connected to the electro-optical substrate. Alternatively, the driving circuits may be formed on an electro-optical substrate of an electro-optical device using liquid crystal and a plurality of wiring substrates connected to the electro-optical substrate. In any cases described above, the same effects as in the first and second embodiments can be obtained.

Applications

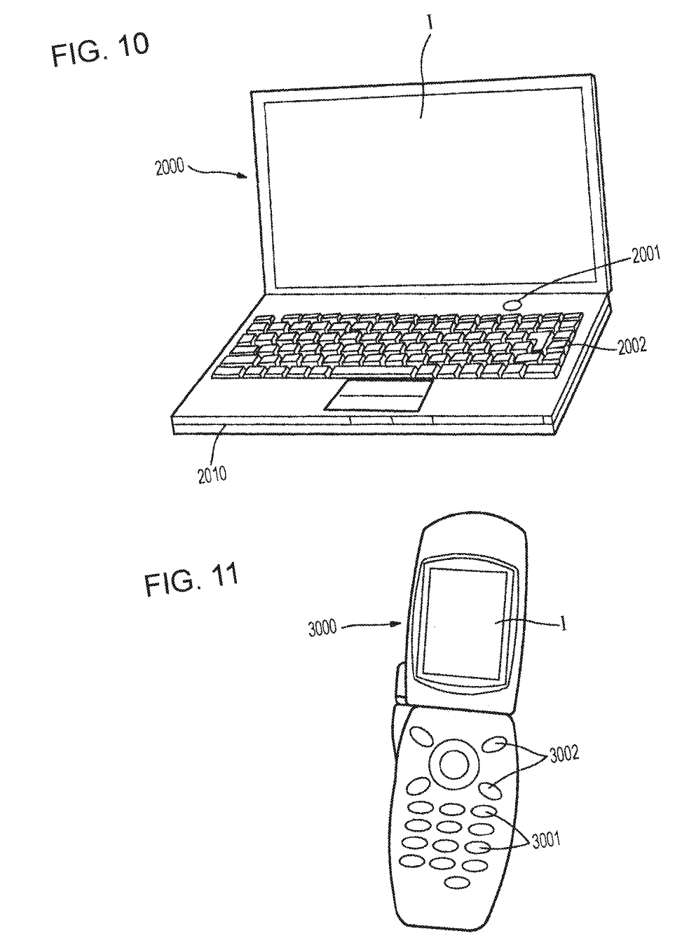

Next, an electronic apparatus to which the electro-optical device I according to the above embodiment is applied will be described. FIG. 10 is a view illustrating the configuration of a portable personal computer to which the electro-optical device I is applied. A personal computer 2000 includes the electro-optical device I serving as a display unit and a main body 2010. The main body 2010 includes a power switch 2001 and a keyboard 2002. Since the electro-optical device I uses the OLED elements 420, it is possible to display a screen that has a wide viewing angle and can be easily viewed.

FIG. 11 is a view illustrating the configuration of a mobile phone to which the electro-optical device I is applied. A mobile phone 3000 includes a plurality of operation buttons 3001, a plurality of scroll buttons 3002, and the electro-optical device I serving as a display unit. By operating the scroll buttons 3002, a screen displayed on the electro-optical device I is scrolled.

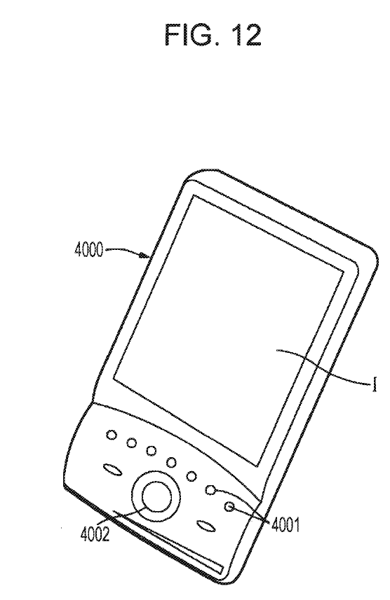

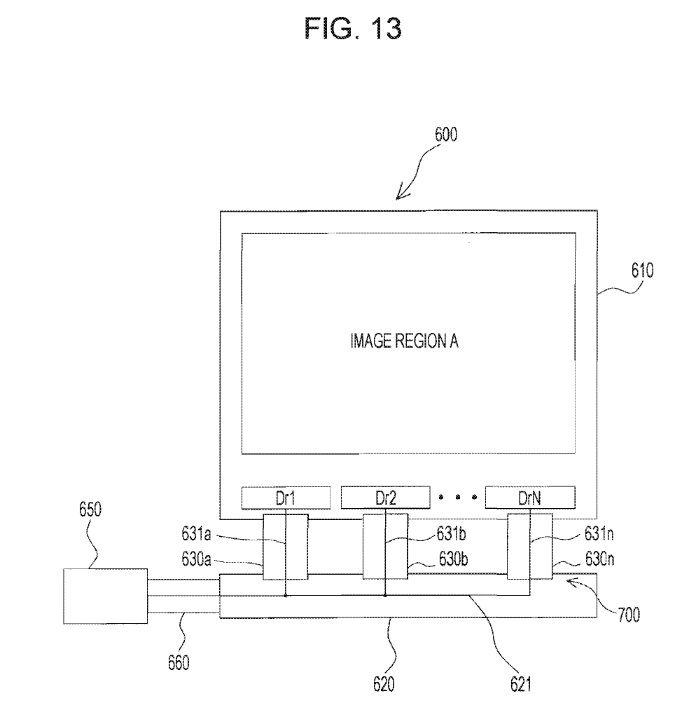

FIG. 12 is a view illustrating the configuration of a personal digital assistant (PDA) to which the electro-optical device I is applied. A personal digital assistant 4000 includes a plurality of operation buttons 4001, a power switch 4002, and the electro-optical device I serving as a display unit. By operating the power switch 4002, various information items, such as an address list or a schedule, are displayed on the electro-optical device I.

Furthermore, the electro-optical device I can be preferably applied to a liquid crystal display device or display devices using self-luminous elements, such as a field emission display (FED) device, a surface-conduction-type emission display (SED) device, or a ballistic electron emission display (BSD) device.

Further, an electronic apparatus to which the electro-optical device I is applied includes a television having a large screen, a computer monitor, a display and illumination device, a mobile phone, a game device, an electronic paper, driving operation panel, a video camera, a digital still camera, a liquid crystal television, a view-finder-type or monitor-direct-view-type video tape recorder, a car navigation apparatus, a pager, an electronic diary, a desktop calculator, a word processor, a workstation, a video phone, a POS terminal, an apparatus having a touch panel, and the like, as well as those shown in FIGS. 10 to 12. In addition, the electro-optical device I can be applied as display units of these various electronic apparatuses. In addition, the electro-optical device I can be effectively applied to a printer or a scanner that uses an electro-optical device as a light source.

The entire disclosure of Japanese Patent Application No. 2005-234047, filed Aug. 12, 2005 is expressly incorporated by reference herein.

What is claimed is:

1. A signal transmission circuit comprising:
an electro-optical substrate having electro-optical elements;
a plurality of driving circuits that drives the electro-optical elements;
a first connection path that electrically connects the plurality of driving circuits; and
a first substrate including at least a part of the first connection path,
wherein the electro-optical substrate is formed of a substrate different from the first substrate.

2. The signal transmission circuit according to claim 1,
wherein the driving circuits are mounted on the electro-optical substrate.

3. The signal transmission circuit according to claim 1,
wherein the first connection path serves as a connection path between the driving circuits adjacent to each other.

4. The signal transmission circuit according to claim1,
wherein the at least a part of the first connection path is formed on the electro-optical substrate and the first substrate.

5. The signal transmission circuit according to claim1,
wherein each of the driving circuits has an approximately rectangular planar shape, and
the at least a part of the first connection path is connected at a longitudinal side of each of the driving circuits having an approximately rectangular planar shape.

6. The signal transmission circuit according to claim 1,
wherein at least a part of a connection path provided on the first substrate has a contact region that is electrically conductive.

7. The signal transmission circuit according to claim 6,
wherein the connection path provided on the first substrate includes a power line, and
a capacitor is mounted on the contact region provided on the power line.

8. The signal transmission circuit according to claim 6,
wherein the connection path provided on the first substrate includes a power line, and
a wiring line for a reduction of the power line impedance is mounted on the contact region provided on the power line.

9. The signal transmission circuit according to claim 8,
wherein the wiring line for a reduction of the power line impedance is commonly connected between a plurality of the first substrates.

10. The signal transmission circuit according to claim 6,
wherein the connection path provided on the first substrate includes a power line, and
the contact region provided on the power line is connected between a plurality of the first substrates.

11. An electro-optical device comprising:
the signal transmission circuit according to claim 1; and
a second substrate having a control circuit that controls the signal transmission circuit.

12. An electronic apparatus comprising:
the electro-optical device according to claim 11; and a circuit that controls the electro-optical device.
